(19) United States
(12) Patent Application Publication
(10) Pub. No.: US 2005/0138288 A1
(43) Pub. Date: Jun. 23, 2005

(54) Dual mode USB and PCI express device

(76) Inventors: Horng-Yee Chou, Palo Alto, CA (US); Ben Wei Chen, Fremont, CA (US); Sun-Teck See, San Jose, CA (US)

Correspondence Address: FORTUNE LAW GROUP LLP, 100 CENTURY CENTER COURT, SUITE 315, SAN JOSE, CA, 95112, US

(21) Appl. No.: 10/746,935

(22) Filed: Dec. 23, 2003

(51) Int. Cl. G06F 12/00

(52) U.S. Cl. 711/115; 711/103; 710/301

(57) ABSTRACT

A flash memory device for connecting to an ExpressCard™ host includes at least one flash memory module, an ExpressCard™ connector for connecting to the ExpressCard™ host, a first serial interface coupled to the ExpressCard™ connector, and a controller coupled to the first serial interface and the at least one flash memory module.

### BACKGROUND OF THE INVENTION

The present invention generally relates to PC modular expansion devices for modular systems and more particularly to a dual mode USB and PCI Express device compatible with the ExpressCard™ architecture.

The ExpressCard™ architecture was unveiled in September, 2003 by the PCMCIA (Personal Computer Memory Card International Association). ExpressCard™ leverages two conventional serial buses, USB 2.0 and PCI Express, to achieve space reduction and enhanced performance.

ExpressCard™ modules will be available in two sizes; a 34 mm wide module generally designated 100 is shown in FIG. 1 and a 54 mm wide module shown generally designated 200 in FIG. 2. Both the 34 mm wide module and the 54 mm wide module are 75 mm long and 5 mm thick. A pin out of an ExpressCard™ module 300 is shown in FIG. 3.

The universal serial bus (USB) is a standard serial electrical interface within the ExpressCard™ standard. A pin out of an ExpressCard™ module 132 using only the USB interface is shown in FIG. 4.

The PCI Express bus is a high speed standard serial electrical interface within the ExpressCard™ standard. A pin out of the ExpressCard™ module 500 using only the PCI Express interface is shown in FIG. 5.

It is anticipated that ExpressCard™ modules will become popular in varied applications. While many mobile and desktop PC chipsets already include USB 2.0 and PCI Express busses, some hosts such as digital cameras may not support both interfaces. As such there is a need in the art for an ExpressCard™ module capable of providing either the USB 2.0 interface or the PCI Express interface on demand.

Flash memory has become an important means for storing data as such memory provides the advantage of mobility and non-erasability. Flash memory is an extremely useful way of storing data for portable devices such as handheld devices. The convenience that flash memory provides gives it numerous advantages over traditional mass storage devices such as hard disks. Besides portability, flash memory further offers advantages such as low power consumption, reliability, small size and high speed.

Flash memory is non-volatile which means that it retains its stored data even after power to the memory is turned off. This is an improvement over standard random access memory (RAM), which is volatile and therefore looses stored data when power is turned off.

In order to provide different functional requirements, current small-sized IA products, such as PDAs, industrial computers, digital cameras, and the like are commonly provided with an operating system, for example, Win CE/Linux. The hardware architecture of these devices requires a CPU and a NOR type flash memory for storing program code. If it is necessary to store data, a SRAM, or built-in NAND flash memory, or an external memory card is needed. These ways of storing data do not provide a standard interface to Win CE/Linux. In order to provide an interface a designer needs to modify the driving program or application program of these operating systems. These modifications require much effort and are costly when developing a new product.

As the number of mobile, portable, or handheld devices grows, the popularity of flash memory increases. The most common type of flash memory is in the form of a removable memory card such as an ExpressCard™ module. Removable cards allow the contents of the flash memory to be transferred easily between devices or computers.

Conventionally, when moving the flash memory card between devices, an additional host or adapter is required in order for the host to communicate with the flash card. Many devices may not have the built-in ability to connect to a flash card, therefore a special adapter or card must be installed in the host device. In addition, the bus architecture can limit the speed of data transfer between the host and flash memory device.

Therefore, there is a need for an ExpressCard™ module capable of providing either the USB 2.0 interface or the PCI Express interface on demand. Such a module preferably includes a flash memory device that can be directly connected to a host device without the need for special cables or adapters.

### SUMMARY OF THE INVENTION

In accordance with one aspect of the invention, a flash memory device for connecting to an ExpressCard™ host includes at least one flash memory module, an ExpressCard™ connector for connecting to the ExpressCard™ host, a first serial interface coupled to the ExpressCard™ connector, and a controller coupled to the first serial interface and the at least one flash memory module.

In another aspect of the invention, a flash memory device for connecting to an ExpressCard™ host includes at least one flash memory module, an ExpressCard™ connector for connecting to the ExpressCard™ host, a PCI Express serial interface coupled to the ExpressCard™ connector, a USB serial interface coupled to the ExpressCard™ connector, and a controller coupled to the USB and PCI Express serial interfaces and the at least one flash memory module.

In yet another aspect of the invention, a flash memory device for connecting to an ExpressCard™ host includes at least one flash memory module, an ExpressCard™ connector for connecting to the ExpressCard™ host, a PCI Express serial interface coupled to the ExpressCard™ connector, a USB serial interface coupled to the ExpressCard™ connector, and a controller coupled to the USB and PCI Express serial interfaces and the at least one flash memory module, the controller comprising a microprocessor coupled to a FIFO system buffer, a flash memory controller, a RAM, and a ROM.

In yet another aspect of the invention, a flash memory device for connecting to an ExpressCard™ host includes at least one flash memory module having a boot state machine, an ExpressCard™ connector for connecting to the ExpressCard™ host, a PCI Express serial interface coupled to the ExpressCard™ connector, a USB serial interface coupled to the ExpressCard™ connector, and a controller coupled to the USB and PCI Express serial interfaces and the at least one flash memory module, the controller comprising a microprocessor coupled to a FIFO system buffer, a flash memory controller, and a RAM.

These and other features, aspects, and advantages of the present invention will become better understood with reference to the following drawings, description, and claims.

### BRIEF DESCRIPTION OF THE DRAWINGS

FIG. 1 is a schematic representation showing a 34 mm ExpressCard™ module;

FIG. 2 is a schematic representation showing a 54 mm ExpressCard™ module;

FIG. 3 is a schematic representation showing a pin out of an ExpressCard™ module;

FIG. 4 is a schematic representation showing a pin out of an ExpressCard™ module using the USB interface;

FIG. 5 a schematic representation showing a pin out of an ExpressCard™ module using the PCI Express interface;

FIG. 6 is a schematic representation showing an ExpressCard™ module using only the USB interface coupled to a host controller that can support both the USB interface and the PCI Express interface in accordance with the invention;

FIG. 7 is a schematic representation showing an ExpressCard™ module using only the PCI Express interface coupled to a host controller that can support both the USB interface and the PCI Express interface in accordance with the invention;

FIG. 8 is a schematic representation showing an ExpressCard™ module using both the USB interface and the PCI Express interface coupled to a host controller that can support both the USB interface and the PCI Express interface in accordance with the invention;

FIG. 9 is a schematic representation showing an ExpressCard™ module using both the USB interface and the PCI Express interface coupled to a host controller that supports the USB interface in accordance with the invention;

FIG. 10 is a schematic representation showing an ExpressCard™ module using both the USB interface and the PCI Express interface coupled to a host controller that supports the PCI Express interface in accordance with the invention;

FIG. 11 is a schematic representation showing an ExpressCard™ module using the PCI Express interface coupled to a host controller that supports the PCI Express interface in accordance with the invention;

FIG. 12 is a schematic representation showing an ExpressCard™ module using the USB interface coupled to a host controller that supports the USB interface in accordance with the invention;

FIG. 13 is a schematic representation showing an ExpressCard™ flash memory device in accordance with the invention;

FIG. 14 is a schematic representation of a flash memory integrated circuit device controller in accordance with the invention;

FIG. 15 is a schematic representation of an alternative embodiment of the flash memory integrated circuit device controller in accordance with the invention;

FIG. 16 is a schematic representation of a flash memory cell in accordance with the invention; and

FIG. 17 is a chart comparing SLC and MLC technologies.

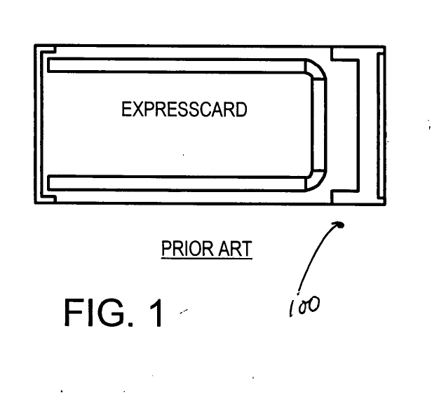

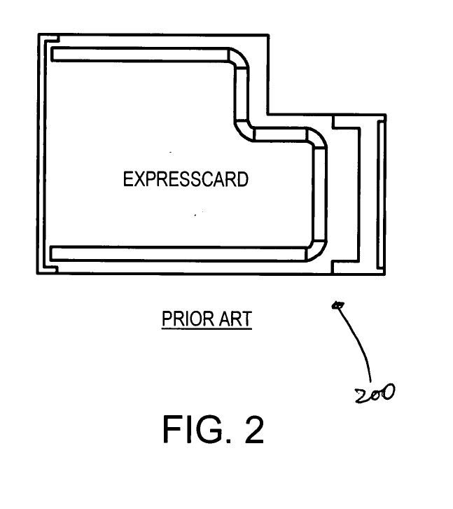

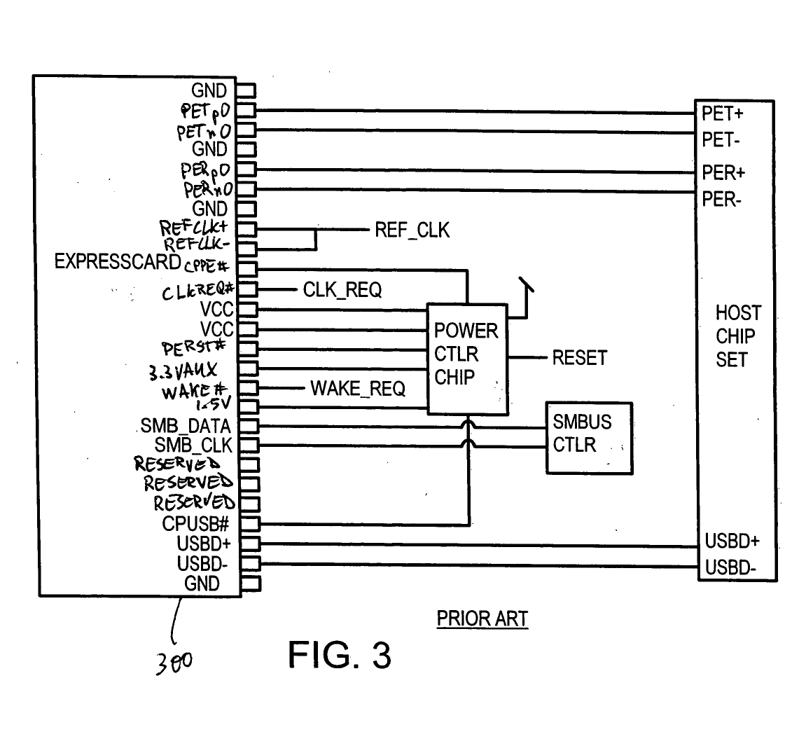

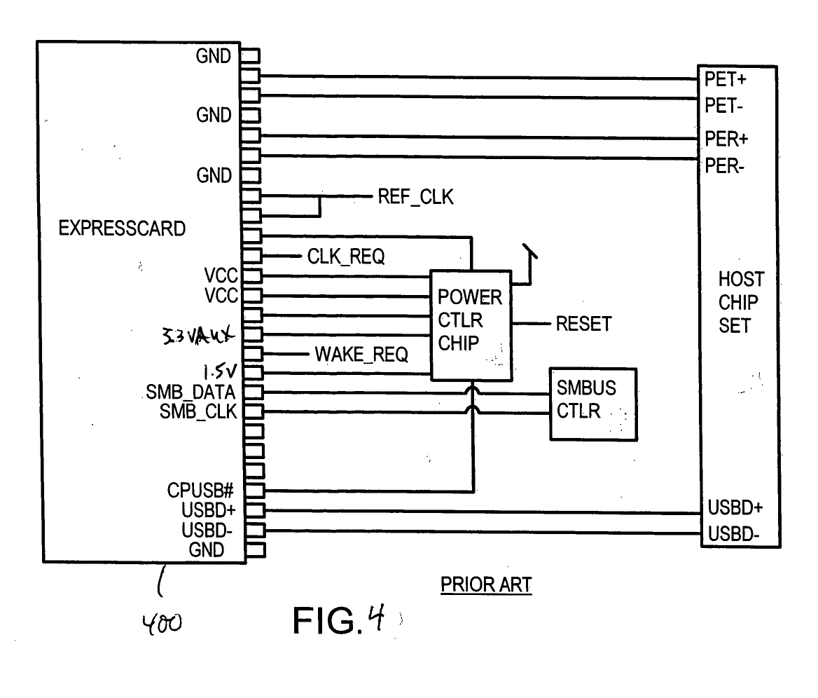

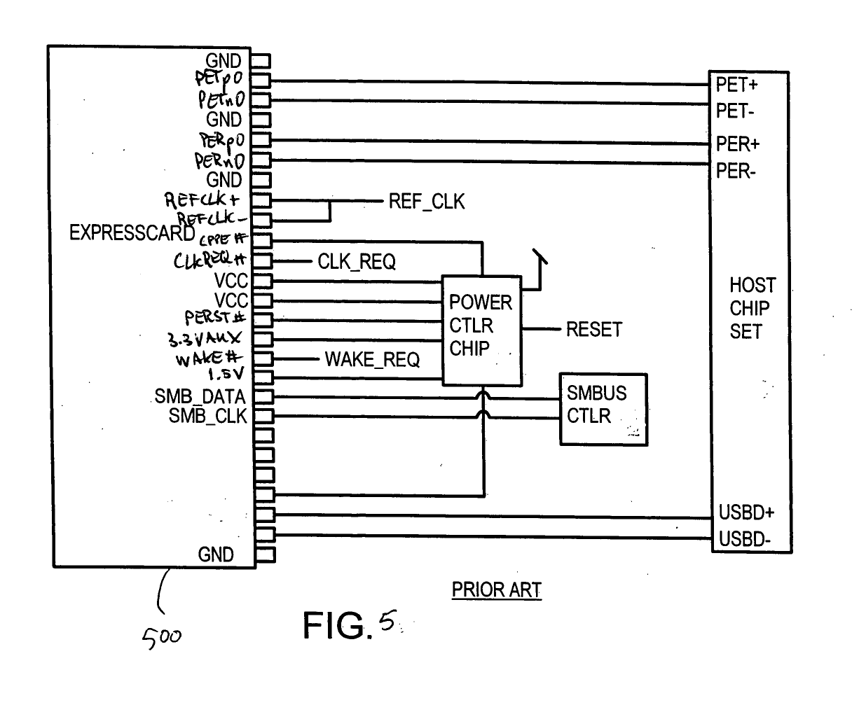

### DETAILED DESCRIPTION OF THE INVENTION

The following detailed description is of the best mode of carrying out the invention. The description is not to be taken in a limiting sense, but is made merely for the purpose of illustrating the general principles of the invention, since the scope of the invention is best defined by the appended claims.

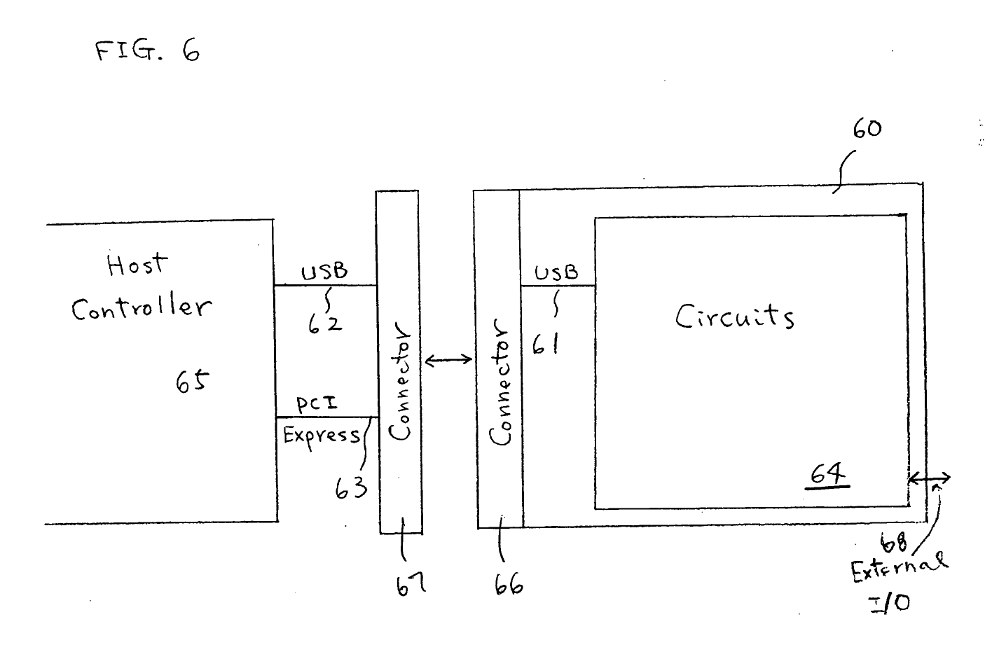

FIG. 6 shows an ExpressCard™ module 60 having a USB interface 61. A host controller 65 may support both the USB interface 62 and the PCI Express interface 63. ExpressCard™ module 60 may include circuits 64 which may include a flash memory and controller. Circuits 64 may include external I/O 68. An ExpressCard™ connector 66 may be coupled to host controller connector 67.

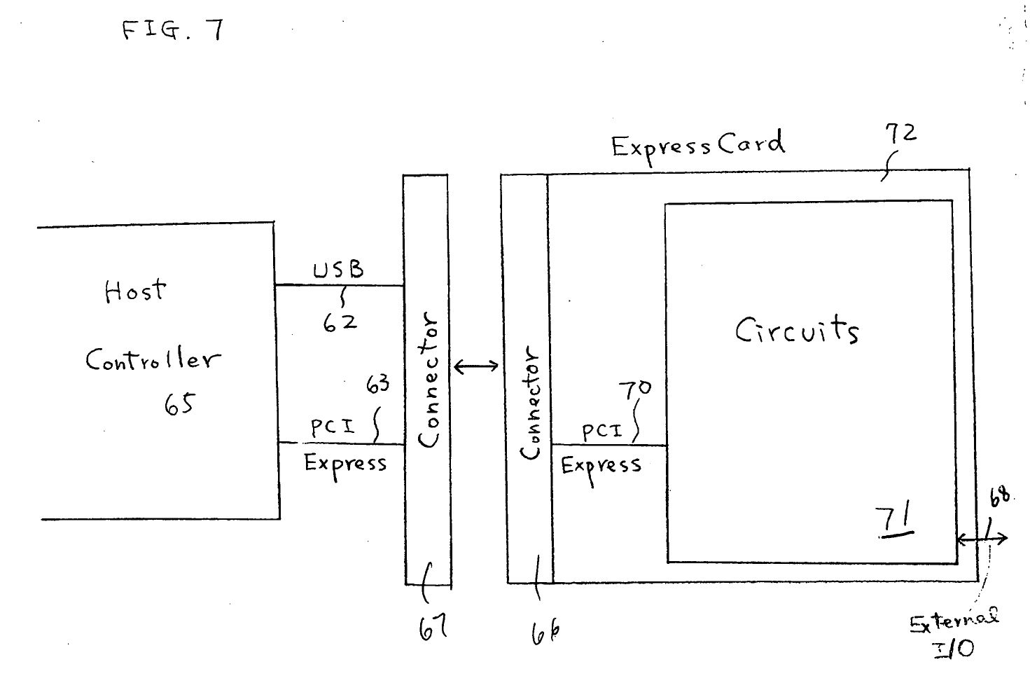

FIG. 7 shows an ExpressCard™ module 72 having a PCI Express interface 70. The host controller 65 may support both the USB interface 62 and the PCI Express interface 63. ExpressCard™ module 72 may include circuits 71 which may include a flash memory and controller. Circuits 71 can include external I/O 68. An ExpressCard™ connector 66 may be coupled to host controller connector 67.

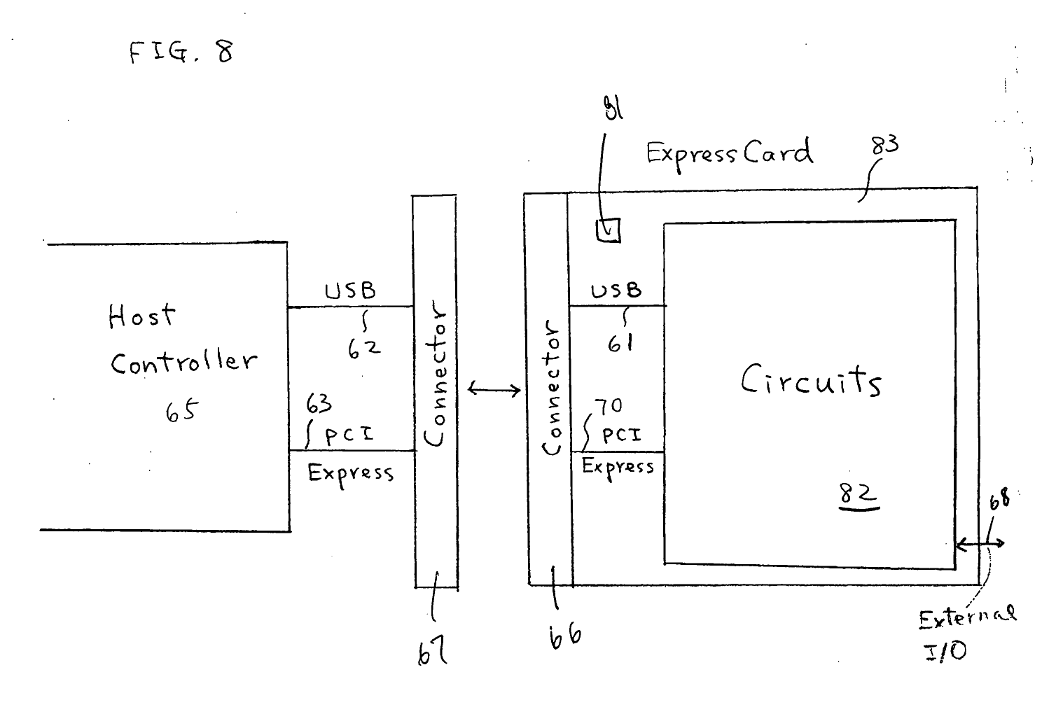

FIG. 8 shows an ExpressCard™ module 83 having the USB interface 61 and the PCI Express interface 70. The host controller 65 may support both the USB interface 62 and the PCI Express interface 63. ExpressCard™ module 83 may include circuits 82 which may include a flash memory and controller. Circuits 82 may include external I/O 68. Host controller 65 may decide which of the USB interface 61 and PCI Express interface 70 to use since both interfaces are available. Alternatively, a switch 81 coupled to circuits 82 may select between the USB interface 61 and the PCI Express interface 70. An ExpressCard™ connector 66 may be coupled to host controller connector 67.

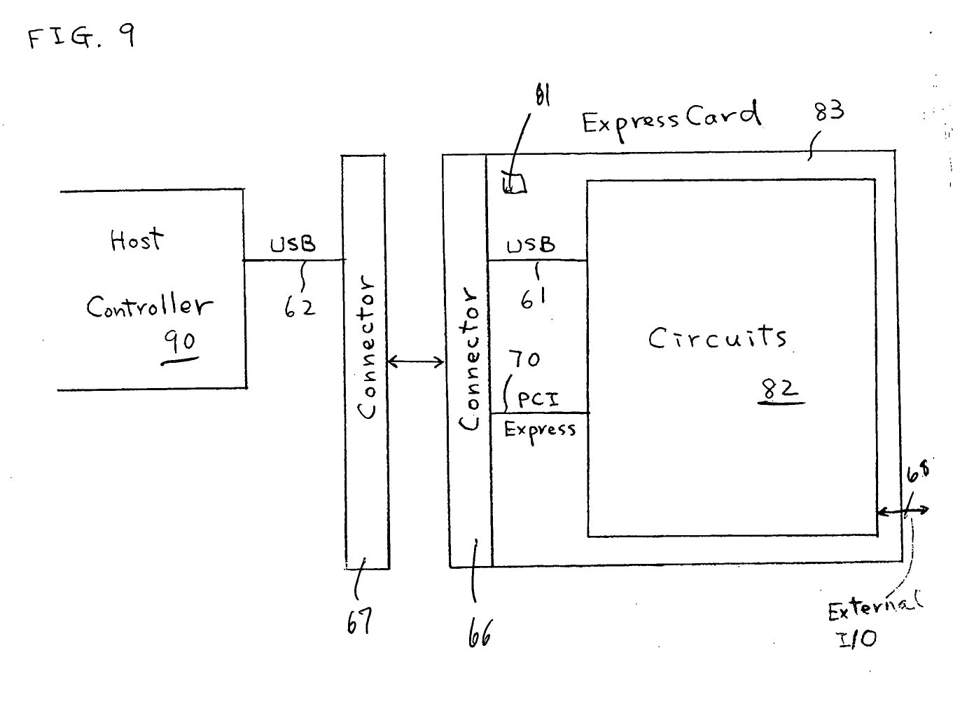

FIG. 9 shows the ExpressCard™ module 83 having the USB interface 61 and the PCI Express interface 70. A host controller 90 supports only the USB interface 62. ExpressCard™ module 83 may include circuits 82 which may include a flash memory and controller. Circuits 82 may include external I/O 68. Switch 81 may be used to select the USB interface 61. An ExpressCard™ connector 66 may be coupled to host controller connector 67.

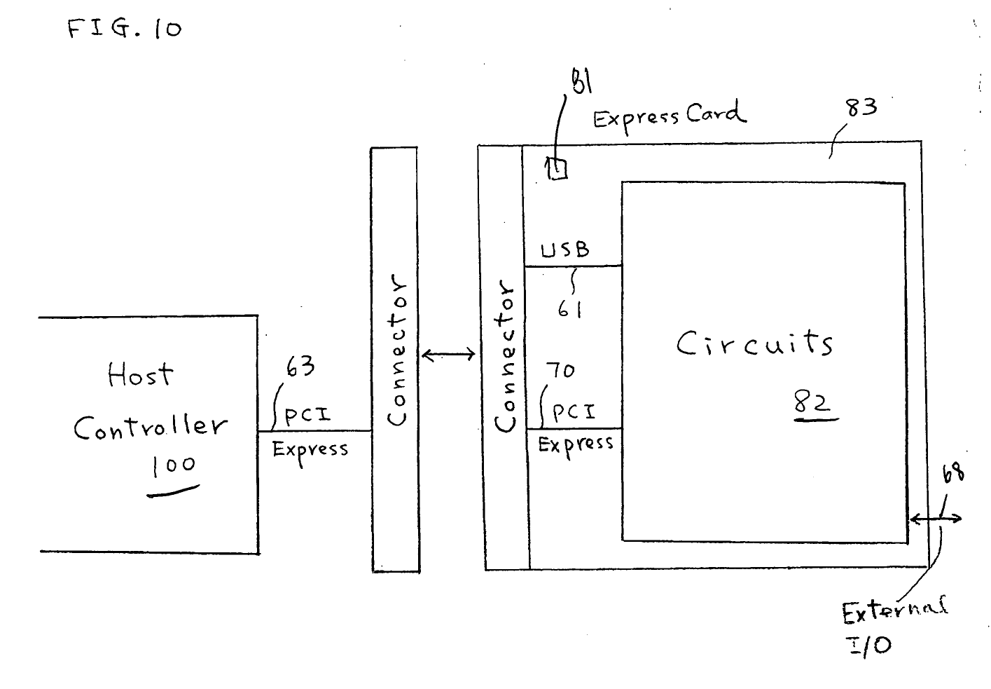

FIG. 10 shows the ExpressCard™ module 83 having the USB interface 61 and PCI Express interface 70. A host controller 100 supports only the PCI Express interface 63. ExpressCard™ module 83 may include circuits 82 which may include a flash memory and controller. Circuits 82 may include external I/O 68. Switch 81 may be used to select the PCI Express interface 70. An ExpressCard™ connector 66 may be coupled to host controller connector 67.

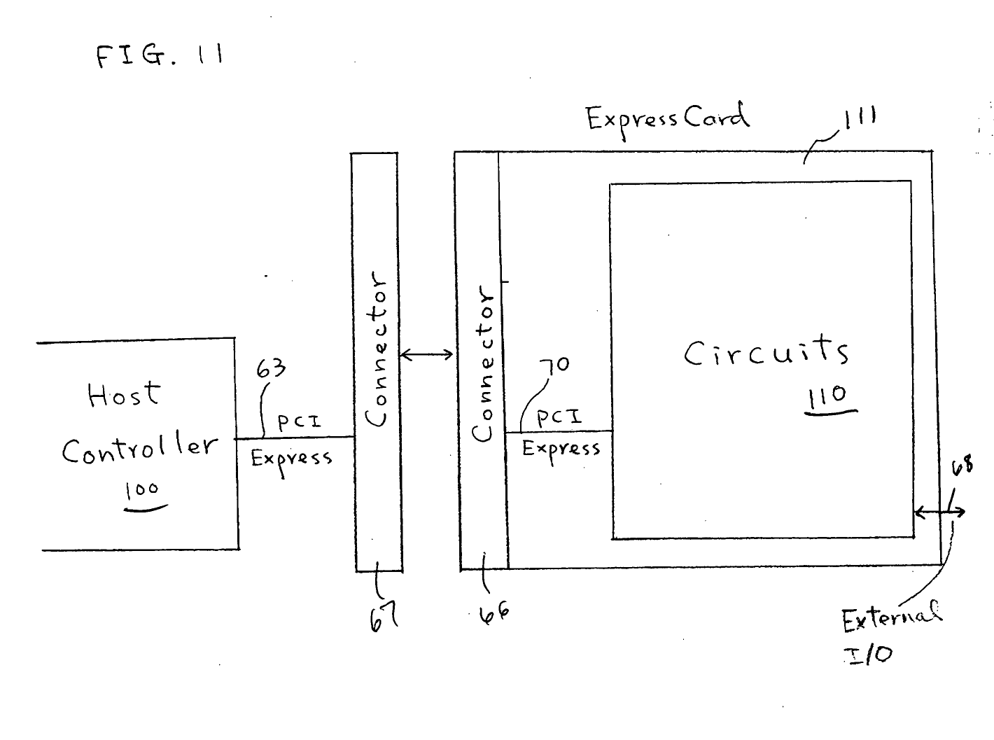

FIG. 11 shows an ExpressCard™ module 111 having the PCI Express interface 70. The host controller 100 supports only the PCI Express interface 63. ExpressCard™ module 111 may include circuits 110 which may include a flash memory and controller. Circuits 110 may include external I/O 68. An ExpressCard™ connector 66 may be coupled to host controller connector 67.

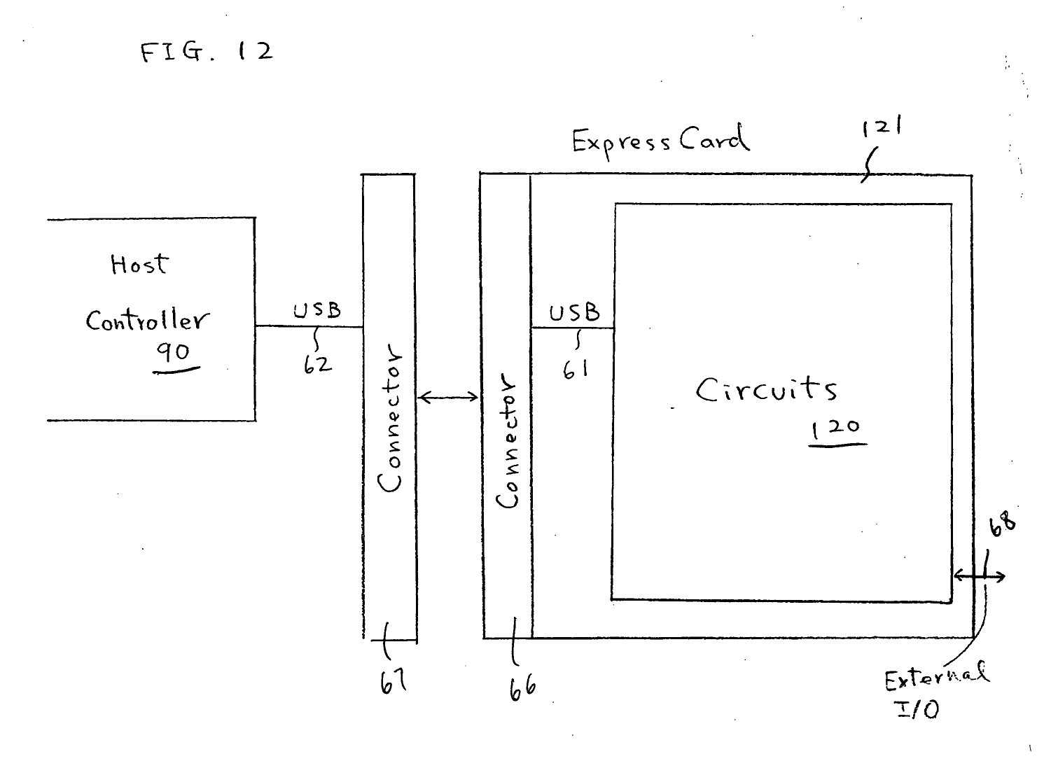

FIG. 12 shows an ExpressCard™ module 121 having the USB interface 61. The host controller 90 supports only the USB interface 62. ExpressCard™ module 121 may include circuits 120 which may include a flash memory and controller. Circuits 120 may include external I/O 68. An ExpressCard™ connector 66 may be coupled to host controller connector 67.

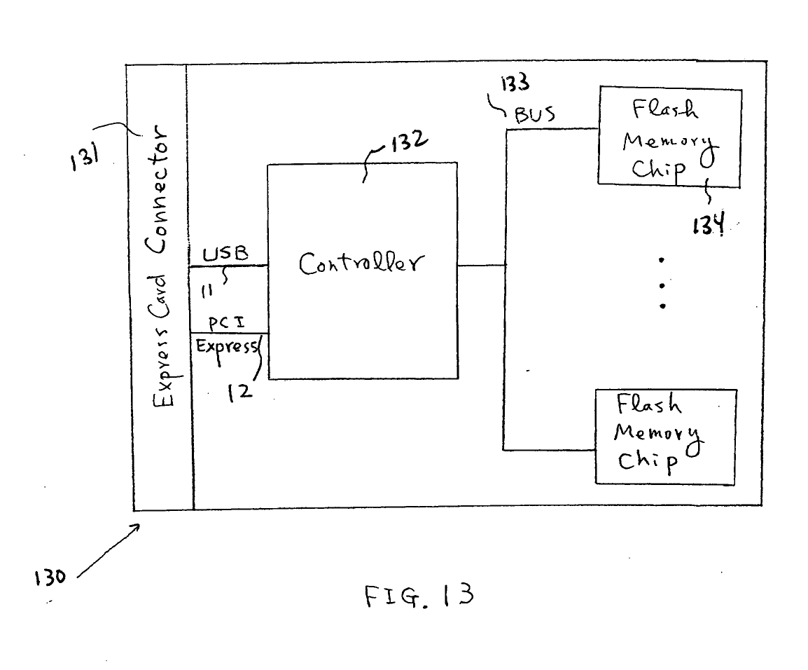

Referring to FIG. 13, ExpressCard™ modules 60, 72, 83, 111, and 121, may be embodied in a flash memory integrated circuit device generally designated 130. Flash memory integrated circuit device 130 may include a controller 132, at least one flash memory chip or module 134, an ExpressCard™ connector 131 adapted for connecting the flash memory integrated circuit device 130 to an external ExpressCard™ host (not shown), a USB electrical interface 11 (modules 60, 83, and 121) and a PCI Express interface 12 (modules 72, 83, and 111). The ExpressCard™ host may include a desktop computer, a notebook computer, a digital camera, a PDA, a cellular phone with or without a digital camera, an MP3 player, a camcorder, an MPEG4 video machine, a digital imaging machine, a hand-held navigation machine, an electronic book, a toy, a voice recorder, and an electronic device.

The controller 132 is a major component of the flash memory integrated circuit device 130. The controller 132 may control commands and data between the ExpressCard™ host and the flash memory integrated circuit device 130. The controller 132 may also manage data in the at least one flash memory chip 134. The controller 132 is preferably of a single chip design that does not need external ROM or RAM.

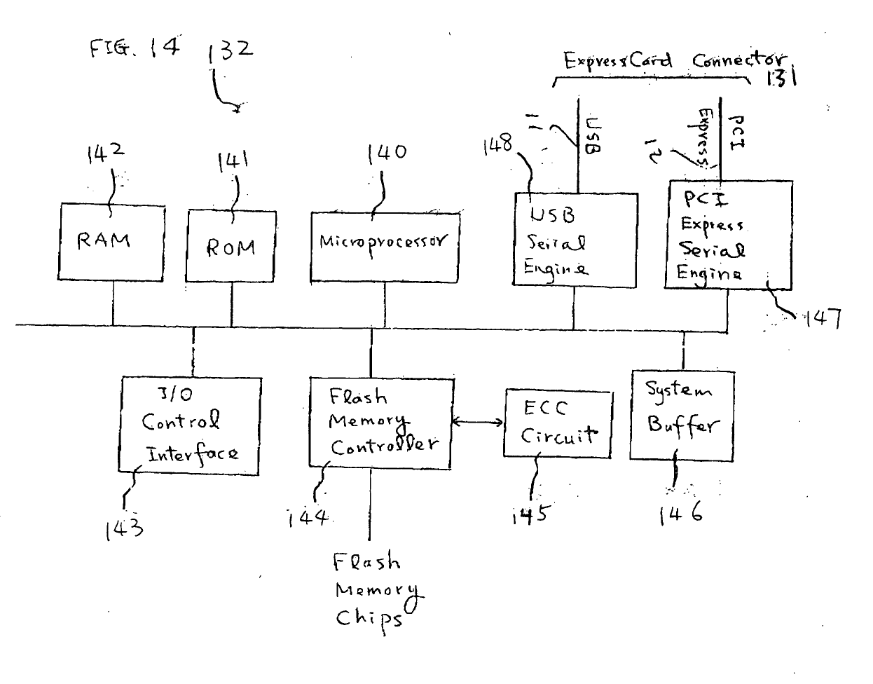

The controller 132 may perform numerous functions. The controller 132 may control the USB interface 11 and the PCI Express interface 12. The controller 132 follows the USB or the PCI Express specification for the electrical and logical protocols of each interface. The controller 132 may further comprise a FIFO controller buffer 146 (FIG. 14). The controller 132 may receive command and parameter packets from the ExpressCard™ host, which are then stored in a special register (not shown) defined by the controller 132. The controller 132 may also be responsible for controlling the transfer of data to and from the ExpressCard™ host. In addition, the controller 132 may also provide status data to the ExpressCard™ host.

When the ExpressCard™ host sends a write command, an interrupt may be generated and sent to a controller microprocessor 140 to inform the microprocessor 140 of the command and a command location. The microprocessor 140, for example a 8 or 16-bit microprocessor, is a major component of the controller 132. The microprocessor 140 may be implemented with an 8 bit 8051 machine. The microprocessor 140 may also be implemented with a 16 bit 80186 machine, a 32 bit ARM CPU, or a 32 or 64 bit MIPS CPU. The microprocessor 140 may read the commands and parameters from the register. The microprocessor 140 may also execute the commands with parameters. The microprocessor 140 may manage and map a FIFO address to the FIFO controller buffer 146 while receiving or transferring data to and from the ExpressCard™ host. Further, the microprocessor 140 may manage commands such as erase, program, or read for the at least one flash memory chip 134. In addition, the microprocessor 140 may execute an addressing method according to an algorithm of the controller 132.

The controller 132 may receive and transfer data to and from the ExpressCard™ host according to the USB or the PCI Express logical and electrical specification within the ExpressCard™ standard. The addressing method may include managing the flash memory erase, read, and write commands and managing the logical to physical mapping.

The controller 132 is the major component of the flash memory integrated circuit 130. The controller 132 may control commands and data between the ExpressCard™ connector 131 and the ExpressCard™ host and manage data in the at least one flash memory chip 134. Preferably the controller 132 is of a single chip design that does not need external ROM or RAM. A bus 133 between the at least one flash memory chip 134 and the controller 132 may be an 8 bit bus. Bus 133 may be a 8-bit, 16-bit, 32-bit or 64-bit bus.

Microprocessor ROM 141 may store program code of the controller 132 and may be built in the controller 132. Microprocessor RAM 142 may be a system RAM used by the controller 132 when executing commands or the controller algorithm. By eliminating the requirement for off-chip memory, the system cost is reduced.

FIFO controller buffer 146 may be used as a cache which may be provided for buffering between a USB Serial Engine 148 and a PCI Express Serial Engine 147 and a flash memory array controller 144. FIFO controller buffer 146 may also serve as the FIFO for each serial protocol. The microprocessor 140 may manage the addresses of the FIFO controller buffer 146. As required, the FIFO controller buffer 146 may be accessed by byte or word.

The flash memory array controller 144 may control the read and write commands to the at least one flash memory chip 134. Preferably, the flash memory array controller 144 is a pure hardware circuit.

An ECC circuit 145 encodes the ECC code while data is writing from the FIFO controller buffer 146 to the flash memory array controller 144 and decodes the ECC code while data is read from the flash memory array controller 144 to the FIFO system buffer 146. If an ECC error occurs, the ECC circuit 145 may determine the address in the buffer cache and correct the error.

As will be appreciated by those skilled in the art, data may flow in two directions. For writing to at least one flash memory chip 134, the data starts from the ExpressCard™ host. The data may move through one of the serial interfaces 11,12 and the ExpressCard™ connector 131 into one of the serial engines 147,148. The data may then be moved to the FIFO system buffer 146. From the FIFO system buffer 146, the data may be moved to the flash memory controller 144 and then to the at least one flash memory chip 134.

For reading from the at least one flash memory chip 134, first the data may be read out of the at least one flash memory chip 134 into the flash memory controller 260. Then the data may be moved into the FIFO system buffer 146. From the FIFO system buffer 146 the data may be moved to one of the serial engines 147,148. Finally, the data may be sent out through one of the serial interfaces 11,12 and the ExpressCard™ connector 131 to the ExpressCard™ host.

The FIFO system buffer 146 may be accessed in multiple ways. A first way may include using the microprocessor 140 to move the data. A second way may include a DMA block (not shown) for use in moving data between one of the serial engines 147,148 and the FIFO system buffer 146 or between the FIFO system buffer 146 and the flash memory controller 144. A third way may include making the serial engines 147,148 and the flash memory controller 144 a bus master and move data directly.

In order to increase the read speed, the FIFO system buffer 146 may be used as a cache. The data can be read ahead. Once the cache hit is detected for a read operation, the data in the cache can be supplied to the requester immediately. No flash memory read operation may be required.

Advantageously, the at least one flash memory chip 134 and controller 132 may be of single chip design to minimize the dimensions of the flash memory integrated circuit device 130 without the need of external RAM or ROM.

In an alternative embodiment of the present invention and with reference to FIG. 15, controller 132 may be replaced by a controller 150. Controller 150 includes a boot state machine 151 which replaces the ROM 141 of controller 132. By taking advantage of the first page “Power-on Auto-read” feature of the at least one flash memory chip 134 when coupling with the boot state machine 151 the microprocessor 140 may boot up from the boot state machine 151 directly. In this manner ROM 141 is eliminated from controller 150. Advantageously, the elimination of ROM 141 provides for reduced gate counts thereby reducing the overall cost of manufacturing controller 150. Furthermore, by storing the control program of the controller 150 in the flash memory, the control program is bug-tolerant and field loadable and upgradeable. While the at least one flash chip 134 may be shipped with a preprogrammed boot loader code that is rarely or never changed, the control program may be upgraded or modified to be up to date. Thus, there may be two copies of the boot loader program and the control program for added security. A related controller is described in commonly owned application “Single-Chip USB Controller Reading Power-On Boot Code from Integrated Flash Memory for User Storage”, Ser. No. 10/707,277 filed on Dec. 2, 2003 and incorporated by reference in its entirety herein.

In operation, a first of the at least one flash memory chips 134 may have a PRE (Power-On-Read-Enable) pin activated. After power up, the microprocessor 140 may be put in reset mode. The boot state machine 151 may then be activated. The boot state machine 151 may monitor the Ready/Busy# signal from a first flash memory chip. When the signal indicates that the first flash memory chip is ready, the boot state machine 151 starts reading the pre-fetched data by using the normal read cycles. The read return data may be sent to the RAM 142. This conventionally means that the flash controller 144 may be a bus master of the local bus. The process continues until enough boot code is relocated from the first flash memory chip into RAM 142. Upon completion, the boot state machine 151 releases the microprocessor reset and the microprocessor 140 may start executing the code stored in RAM 142. The remaining code may be loaded by the microprocessor 140 using the boot load program stored in RAM 142.

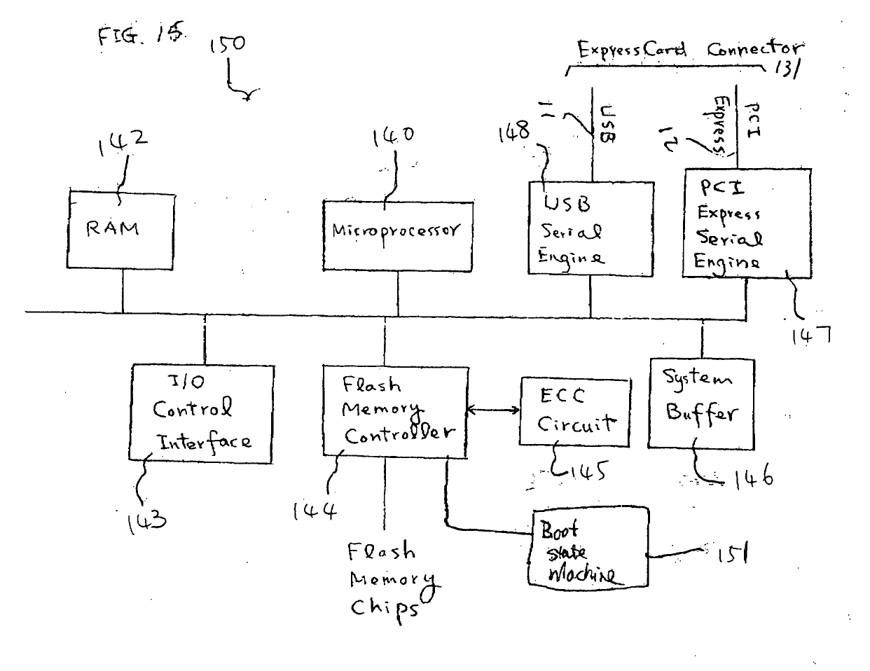

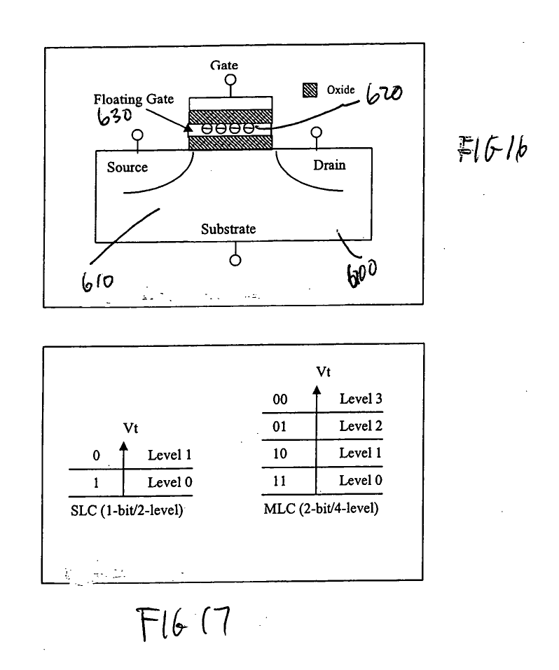

In another alternative embodiment of the present invention, the at least one flash memory chip 134 may include a multi level cell (MLC) flash memory. Conventionally and as shown in FIG. 16, a basic flash memory cell 600 includes a transistor 610 characterized by a specific threshold voltage (Vt) level. Electrical charge 620 is stored on a floating gate 630 of each cell 600.

Typical flash memory uses single level cell (SLC) flash memory with Vt levels such as shown in FIG. 17. MLC technology enables storage of multiple bits per cell by charging the floating gate of a transistor to more than two levels by precisely controlled injection of electrical charges. Two bit MLC has four voltage levels as shown in FIG. 17. Three bit MLC has eight voltage levels and N bit MLC has 2^{N} voltage levels. MLC effectively reduces cell area as well as the die size for a given cell density and leads to a significantly reduced unit cost-per-megabyte. This is important for devices such as mass storage, where concerns of space and cost prevail. As there are more voltage levels in MLC, an enhanced ECC/EDC may be needed to account for better data reliability and the longer programming time needed to manipulate the voltage levels.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A flash memory device for connecting to an ExpressCard™ host comprising:
at least one flash memory module;
an ExpressCard™ connector for connecting to the ExpressCard™ host;
a first serial interface coupled to the ExpressCard™ connector; and
a controller coupled to the first serial interface and the at least one flash memory module.

2. The flash memory device of claim 1, wherein the at least one flash memory module comprises a SLC flash memory module.

3. The flash memory device of claim 1, wherein the at least one flash memory module comprises a MLC flash memory module.

4. The flash memory device of claim 1, wherein the first serial interface comprises a USB serial interface.

5. The flash memory device of claim 1, wherein the first serial interface comprises a PCI Express serial interface.

6. The flash memory device of claim 1, wherein the ExpressCard™ connector comprises a 34 mm connector.

7. The flash memory device of claim 1, wherein the ExpressCard™ connector comprises a 54 mm connector.

8. The flash memory device of claim 1, wherein the controller comprises a microprocessor coupled to a FIFO system buffer, a flash memory controller, a RAM, and a ROM.

9. The flash memory device of claim 8, wherein the controller further comprises an ECC circuit coupled to the flash memory controller.

10. The flash memory device of claim 8, wherein the at least one flash memory module is coupled to the flash memory controller.

11. The flash memory device of claim 1, wherein the controller comprises a microprocessor coupled to a FIFO system buffer, a flash memory controller, and a RAM.

12. The flash memory device of claim 11, further comprising a boot state machine coupled to the flash memory controller.

13. A flash memory device for connecting to an ExpressCard™ host comprising:
at least one flash memory module;
an ExpressCard™ connector for connecting to the ExpressCard™ host;
a PCI Express serial interface coupled to the ExpressCard™ connector;
a USB serial interface coupled to the ExpressCard™ connector; and
a controller coupled to the USB and PCI Express serial interfaces and the at least one flash memory module.

14. The flash memory device of claim 13, wherein the at least one flash memory module comprises a SLC flash memory module.

15. The flash memory device of claim 13, wherein the at least one flash memory module comprises a MLC flash memory module.

16. The flash memory device of claim 13, wherein the ExpressCard™ connector comprises a 34 mm connector.

17. The flash memory device of claim 13, wherein the ExpressCard™ connector comprises a 54 mm connector.

18. The flash memory device of claim 13, wherein the controller comprises a microprocessor coupled to a FIFO system buffer, a flash memory controller, a RAM, and a ROM.

19. The flash memory device of claim 18, wherein the controller further comprises an ECC circuit coupled to the flash memory controller.

20. The flash memory device of claim 18, wherein the at least one flash memory module is coupled to the flash memory controller.

21. The flash memory device of claim 13, wherein the controller comprises a microprocessor coupled to a FIFO system buffer, a flash memory controller, and a RAM.

22. The flash memory device of claim 21, further comprising a boot state machine coupled to the flash memory controller.

23. The flash memory device of claim 13, further comprising a switch coupled to the controller for selecting between the PCI Express serial interface and the USB serial interface.

24. A flash memory device for connecting to an ExpressCard™ host comprising:
at least one flash memory module;
an ExpressCard™ connector for connecting to the ExpressCard™ host;
a PCI Express serial interface coupled to the ExpressCard™ connector;
a USB serial interface coupled to the ExpressCard™ connector; and
a controller coupled to the USB and PCI Express serial interfaces and the at least one flash memory module, the controller comprising a microprocessor coupled to a FIFO system buffer, a flash memory controller, a RAM, and a ROM.

25. The flash memory device of claim 24, wherein the at least one flash memory module comprises a SLC flash memory module.

26. The flash memory device of claim 24, wherein the at least one flash memory module comprises a MLC flash memory module.

27. The flash memory device of claim 24, wherein the ExpressCard™ connector comprises a 34 mm connector.

28. The flash memory device of claim 24, wherein the ExpressCard™ connector comprises a 54 mm connector.

29. The flash memory device of claim 24, further comprising a switch coupled to the controller for selecting between the PCI Express serial interface and the USB serial interface.

30. A flash memory device for connecting to an ExpressCard™ host comprising:
at least one flash memory module having a boot state machine;
an ExpressCard™ connector for connecting to the ExpressCard™ host;
a PCI Express serial interface coupled to the ExpressCard™ connector;
a USB serial interface coupled to the ExpressCard™ connector; and
a controller coupled to the USB and PCI Express serial interfaces and the at least one flash memory module, the controller comprising a microprocessor coupled to a FIFO system buffer, a flash memory controller, and a RAM.

31. The flash memory device of claim 30, wherein the at least one flash memory module comprises a SLC flash memory module.

32. The flash memory device of claim 30, wherein the at least one flash memory module comprises a MLC flash memory module.

33. The flash memory device of claim 30, wherein the ExpressCard™ connector comprises a 34 mm connector.

34. The flash memory device of claim 30, wherein the ExpressCard™ connector comprises a 54 mm connector.

35. The flash memory device of claim 30, further comprising a switch coupled to the controller for selecting between the PCI Express serial interface and the USB serial interface.
